(19) United States
(12) Patent Application Publication
(10) Pub. No.: US 2013/0006961 A1
(43) Pub. Date: Jan. 3, 2013

(54) DATA DRIVEN NATURAL INTERFACE FOR AUTOMATED RELATIONAL QUERIES

(75) Inventors: Jonathan McPherson, Redmond, WA (US); Roderic Lewis, Maple Valley, WA (US)

(73) Assignee: Microsoft Corporation, Redmond, WA (US)

(21) Appl. No.: 13/172,627

(22) Filed: Jun. 29, 2011

(51) Int. Cl. G06F 17/30

(52) U.S. Cl. 707/714; 707/769; 707/E17.017

(57) ABSTRACT

A data driven natural interface is provided for automated relational queries. Multiple datasets are displayed in an easily selectable manner on a surface. Upon detecting selection and movement of a dataset to another surface, the moved data is presented on the other surface. Upon detecting selection and movement of another dataset to the other surface, a join path between the moved datasets is computed, the datasets joined, and results displayed on the other surface. The system continues to join newly selected data with existing data as new datasets are moved to the other surface allowing query results to take shape before the user's eyes, without a need to test or execute the query.

### BACKGROUND

Modern technology has enabled rapid computing on the go to meet variety of user demands. Advances in technology have permeated integrated circuits across a variety of platforms such as portable devices. Technology has expanded utility of machines such as automobiles. Technological expansion has led to increased system complexity. The increase in complexity resulted in added diversity in common daily tasks and consumption of information. In the diverse world, global network of devices continue to generate and consume information stored in databases at ever increasing rates never before experienced in civilization.

In traditional database clients, users are enabled to interact and combine database tables using specific queries. Standardized syntax is utilized to construct queries to combine datasets according to user demand. However, demand for complex database table combinations can tax database expert user resources. Limited database expert user availability may impact downstream project progress and diminish productivity. In the data centric world, providing specific data driven solutions may impact business survivability when data consumer demand outweighs business capacity to accommodate such demand.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing a data driven natural interface for automated relational queries. An application may display multiple datasets in an easily selectable manner on a surface. Upon detecting selection and movement of a dataset to another surface, the moved data may be presented on the other surface. Upon detecting selection and movement of another dataset to the other surface, a join path between the moved datasets may be computed, then the datasets joined and results displayed on the other surface. According to some embodiments, the system may continue to join newly selected data with existing data as new datasets are moved to the other surface allowing query results to take shape before the user's eyes, without a need to test or execute the query.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating example components of a system employing a data driven natural interface for automatically composing and executing relational queries in a client application;

FIG. 2 illustrates an example action diagram of a data driven natural interface for automatically composing relational queries;

FIG. 3A through 3C illustrate examples providing a data driven natural interface for automatically composing relational queries according to some embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process employing a data driven natural interface for automatically composing relational queries according to embodiments.

### DETAILED DESCRIPTION

As briefly described above, a data driven natural interface may be used in a client application to compose relational queries automatically. Multiple datasets may be displayed on a surface. A dataset may be displayed on another surface upon detecting dragging of the dataset from the surface to the other surface. Upon detecting dragging of another dataset to the other surface, a join operation may be performed between the dragged datasets and results displayed on the other surface without manual intervention or query construction. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a non-transitory computer readable memory device. The computer-readable storage medium can for example be implemented via one or more of a volatile computer memory, a non-volatile memory, a hard drive, a flash drive, a floppy disk, or a compact disk, and comparable physical storage media.

Throughout this specification, the term “platform” may be a combination of software and hardware components utilizing a data driven natural interface for composing relational queries. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A user interface according to some embodiments may be a two-pane interface according to an embodiment. The panes may be adjacent to each other. The panes may be divided by an adjustable divider. One of the panes may show datasets such as data tables from a database. The datasets may be populated by individual records. An application managing the user interface may scale the size of the datasets to fit all of the datasets stored in the database into the pane. The application may also display a scrollable data table structure to enable the datasets to fit into the pane. Alternatively, the application may allow a user to select only a number of datasets to be displayed. In one example, the application may load dataset names into a selection control such as a drop down menu and allow a user to click on the dataset name to display in the pane. In other embodiments, the surfaces for displaying the datasets may have any shape or size. For example, the first surface for displaying the datasets to be selected may be a bound pane while the second surface displaying the selected datasets and join results may be a location on the desktop.

Furthermore, embodiments are not limited to retrieving datasets from a database. A data store maintaining the datasets may be any entity storing data records in datasets. Such a data store may include a collection of files, a data service, a data server, etc. An example data store may be a collection of extensible markup language (XML) files. Other examples may include relational and object-oriented database services. Examples of databases are not provided in a limiting sense and may include other embodiments.

Embodiments enable a data driven natural interface for automatically composing relational queries. A data driven natural interface may shift query construction duty from a user to a database. A user may be enabled to simply select and join desired datasets without writing a query. The database may handle query construction in addition to traditional database functions such as query execution and dataset presentation. While references are made to a client application and a database throughout the Specification and Claims, embodiments are not limited to a particular client application or a database. Any application and data store may be used applying the principles discussed herein.

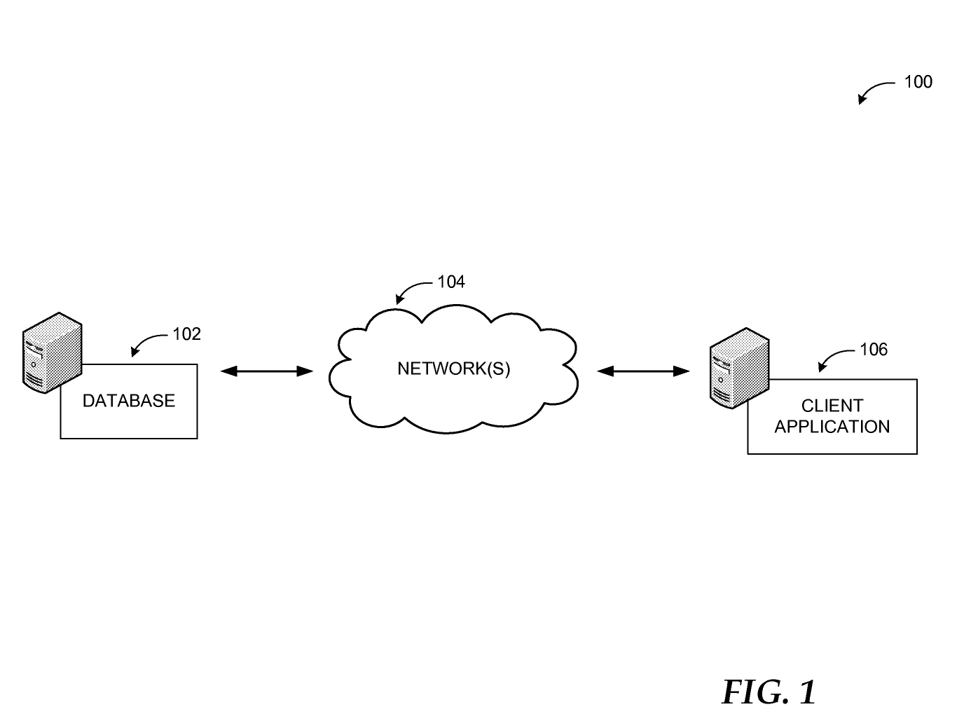

FIG. 1 is a diagram illustrating example components of a system employing a data driven natural interface for automatically composing and executing relational queries in a client application. In diagram 100, a server may host a database 102 such as a data store providing information services to clients. An example natural user interface may present stored datasets in the database 102 to a user. The database 102 may receive and execute requests such as queries to retrieve the datasets. In one example implementation, queries may be provided in SQL query language syntax.

Some embodiments enable gesture based joining of datasets without the need to write a query. The server hosting the database 102 may store records in datasets. The client application 106 may display datasets such as data tables on a surface (user interface). The user may be enabled to drag and drop the datasets to another surface. When a user drags and drops another dataset into the other surface, the client application 106 may request a combined dataset from the database 102. The request may be in the form of a join query. The database 102 may construct the join query based on parameters of the request such as which datasets to join. Alternatively, the client application 106 may construct the query and transmit the query to the database 102 as the request for the combined dataset.

The network 104 may be a local network or may be an external entity such as an Internet based infrastructure. It may provide wired or wireless connectivity. Client application 106 and the database 102 may connect to each other through unsecured or secured connectivity. An example of a secured connectivity may be a Virtual Private Network (VPN) established among the clients and the data service with the use of encrypted communications.

In an alternative embodiment, the database 102 may be a remote or a local database. A local database may be limited to local computing resources such as CPU, memory, and storage resources available to the system executing the client application. A remote database may be less restricted regarding computing resources and take advantage of non-local computing resources. However, when utilizing a remote database, the overall system may have to be optimized for network latency. Alternatively, the client application 106 may host the database 102 as a component of the client application. Embodiments are not limited to client/server and peer-to-peer architectures. Employing a data driven natural interface to compose relational queries in client applications may be accomplished using other architectures.

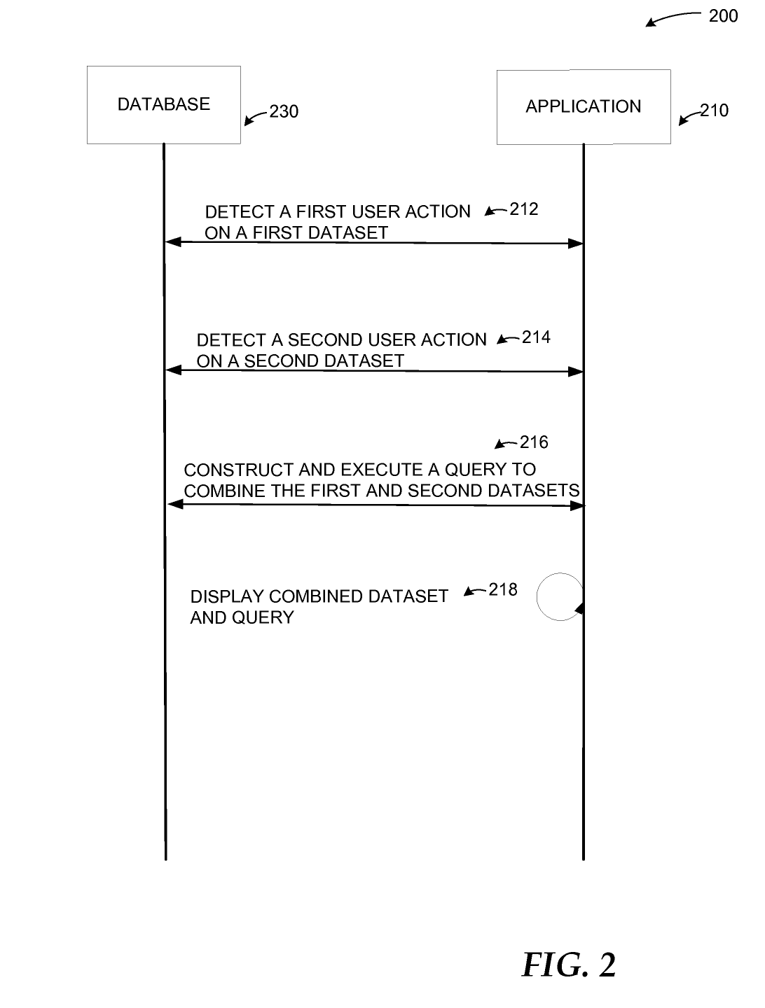

FIG. 2 illustrates an example action diagram of a data driven natural interface for automatically composing relational queries. An application 210 may display datasets retrieved from a database 230 on a first surface. The first surface may be of any shape and form. The application may resize datasets to fit the viewable first surface. The datasets may store multiple records. Each record may be contained in a data row. Each data row may be further segmented into individual data cells. Data cells may belong to dataset entities called data columns. Each data column in a grid may represent an attribute of the dataset. A common attribute of a dataset in a relational database is a primary key. Primary keys are unique numbers that are used to refer to the data rows. Another common entity in a relational database is a foreign key. Foreign keys store primary keys from other datasets to create a relationship between the dataset and the other datasets.

A user may initiate operations in diagram 200 by engaging the application 210. The application may be displaying datasets from the database 230 on a first surface. The first surface may be separated from the second surface by a divider or the surfaces may be at distinct locations on the user's desktop. The application 210 may detect a first user action such as dragging and dropping a first dataset from the first surface onto the second surface (212). The application may display the records of the dataset on the second surface upon completion of the first user action.

Next, the application 210 may detect a second user action such as dragging and dropping a second dataset onto the second surface from the first surface 214. Upon detecting the second user action, the application 210 may request the database 230 to construct and execute a query to combine the first and second datasets 216. The database 230 may perform the request and transmit the combined dataset to the application 210. The application 210 may display the combined dataset 218, which overwrites the initial display of the first dataset on the second surface. The application may also display the query and enable the user to interact with the query to alter the records displayed in the combined dataset.

The described data driven natural interface to compose relational queries is for illustration purposes. Other data driven natural interfaces may be used to compose and execute relational queries. Furthermore, a database (e.g., relational database, object oriented database, a spreadsheet application, web service, XML file(s), etc.) may be stored by the application executed on the computing device itself, instead of a communicatively coupled service. For example, a user action to combine two datasets from a first surface in a second surface may cause the retrieval of combined dataset from a locally stored database.

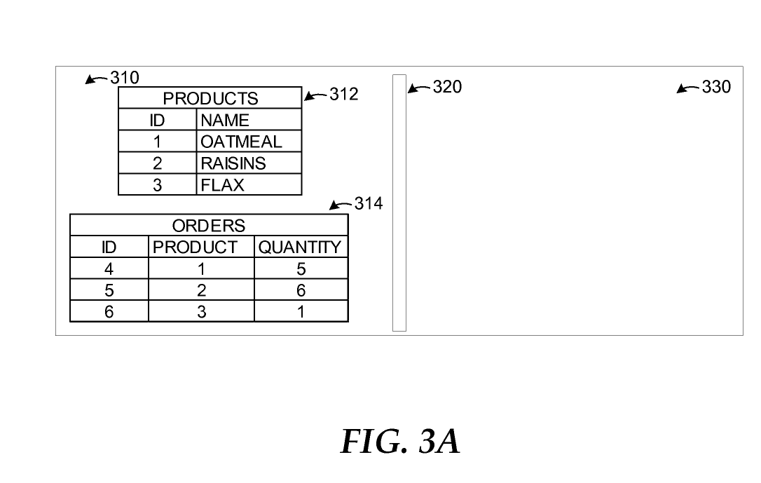

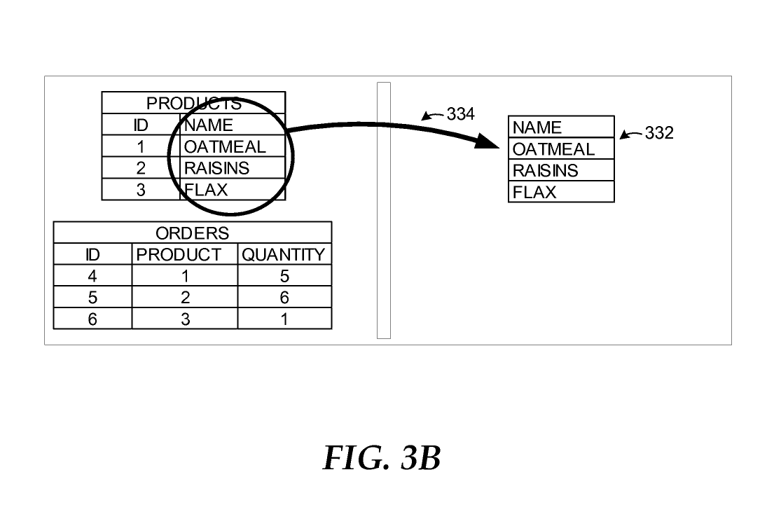

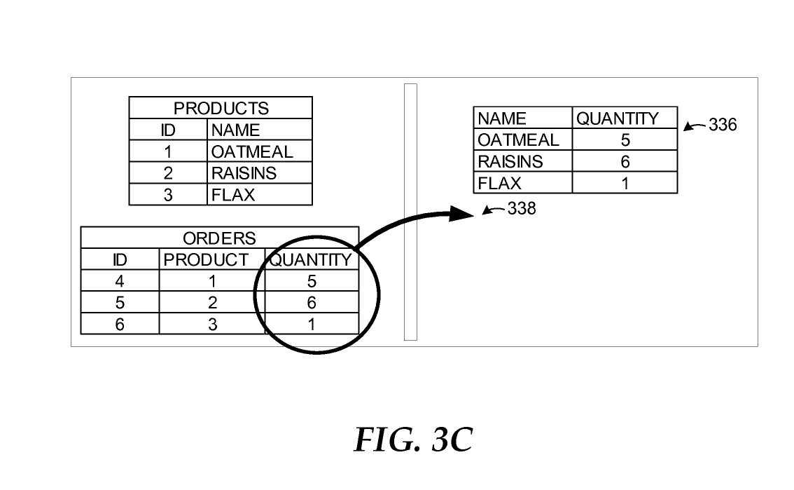

FIG. 3A through FIG. 3C illustrate examples providing a data driven natural interface for automatically composing and executing relational queries according to some embodiments. FIG. 3A displays an example user interface with two surfaces for composing relational queries. The first surface 310 displays two datasets, “PRODUCTS” data table 312 and “ORDERS” data table 314. The second surface 330 is divided from the first surface 310 by a divider 320.

The first surface 310 may be positioned adjacent to the second surface 330. The first surface may be positioned left of the second surface. Alternatively, the first surface may be positioned on top of the second surface or in a different location on the user's desktop. In other embodiments, the positions of the first and second surfaces may be switched by another user action such as clicking a switch position button or switch option in a menu. Additionally, the positions of the first and second surfaces may be switched by a predetermined device setting such as a screen size. A screen size limitation on a mobile device may determine whether to allocate more screen estate to second surface to enable the user to accomplish complex dataset join operations.

FIG. 3B illustrates the first user action. The user may accomplish the first user action by selecting a first data column from the first data table 312. The user may grab and move a first data header (334), such as “NAME” from the first data column. Upon drag and drop completion, the application may display the contents of the dataset 332 on the second surface. Alternatively, the user may choose to drag and drop a row of records by grabbing and moving a primary key corresponding to the row. In yet another example, the user may grab and move a single data cell. Examples of the first dataset are not limited to a data column, row or cell but may be combination of singular or multiple of each.

Additionally, upon completion of the first user action, the second surface may display in real time the query executed by the database to retrieve the first dataset displayed on the second surface. The application may allow the user to alter the query and display the resulting dataset in real time on the second surface.

In FIG. 3C, the application may detect a second user action dragging and dropping a second dataset onto the second surface. Similar to the first user action, the user may drag and drop a dataset from the “ORDERS” data table (338). The dataset may be a data cell, a data row, or a data column. The second user action may be grabbing and moving a second data header of the second data column (e.g.: “QUANTITY”) to drag the second dataset into the second surface from the first surface. The drag and drop action may include moving the selected dataset next to the first dataset already on the first surface or simply to any location on the first surface.

Upon completion of the drag and drop action 338, the application may request a combined dataset 336. The database may generate and execute a query according to the specifics of the request which may include the data table and column names to combine. The database may execute a one-to-many join type query joining the first dataset with the second dataset on a foreign key of the first dataset in the second dataset. In an alternative embodiment, the roles of the first and second datasets may be reversed and the database may execute a many-to-one join type query joining the first dataset with the second dataset on a foreign key of the second dataset in the first dataset. In yet another embodiment, the first and second datasets may not have the other's foreign key. In such a scenario, the database may attempt to find a set of intermediate tables through which a join path may be created from the first dataset to the second, and use this join path if it is found. If such a path is not found, it may execute a many-to-many join type query joining the first dataset with the second dataset by creating a matrix for each element of the first dataset with each element of the second dataset. Determination of query type may depend on choice of the dataset and how the datasets relate to each other. The query for the combined dataset may be displayed on the second surface in real time in relation to any user action dragging and dropping a dataset from the first surface onto the second surface.

Embodiments are not limited to first and second user actions. The client application may enable the user to accomplish additional user actions to display new combined datasets by dragging and dropping other datasets from the first surface into the second surface. The client application may request new combined dataset and new query to display the new recombined dataset upon completion of the additional user action.

The scenarios discussed above are provided as example embodiments. Other scenarios may be used to provide a data driven natural interface to automatically compose and execute relational queries in client applications using the principles discussed herein.

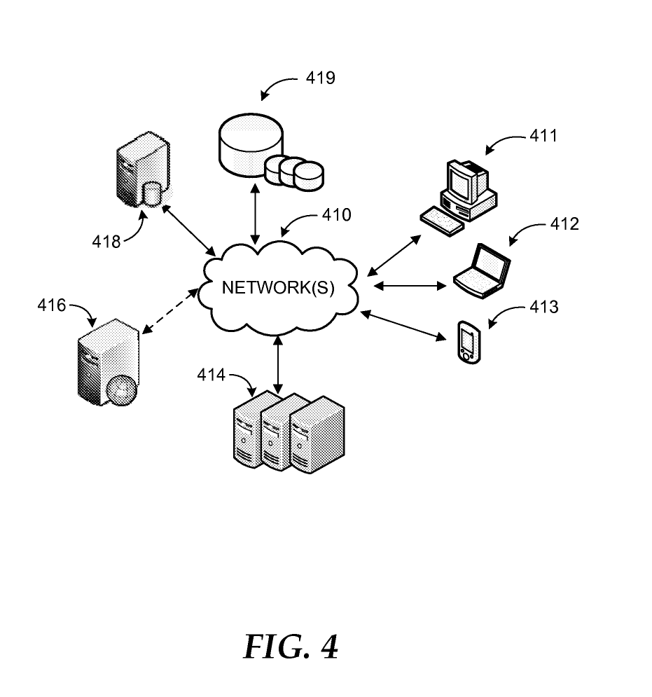

FIG. 4 is an example networked environment, where embodiments may be implemented. Data services may be provided via software executed over one or more servers 414 or a single server (e.g. web server) 416 such as a hosted service. The platform may communicate with client applications on individual computing devices such as a smart phone 413, a laptop computer 412, or tablet computer 411 (‘client devices’) through network(s) 410.

As discussed above, a client application may enable a data driven natural interface for composing relational queries. Datasets may be combined by drag and drop user actions on the client devices 411-413. The query to combine the datasets may be displayed along with the combined dataset. The user may be allowed to alter the query to change the combined dataset.

Client devices 411-413 may enable access to applications executed on remote server(s) (e.g. one of servers 414) as discussed previously. The server(s) may retrieve or store relevant data from/to data store(s) 419 directly or through database server 418.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed for a data driven natural interface to compose and execute relational queries. Furthermore, the networked environments discussed in FIG. 4 are for illustration purposes only. Embodiments are not limited to the example applications, modules, or processes.

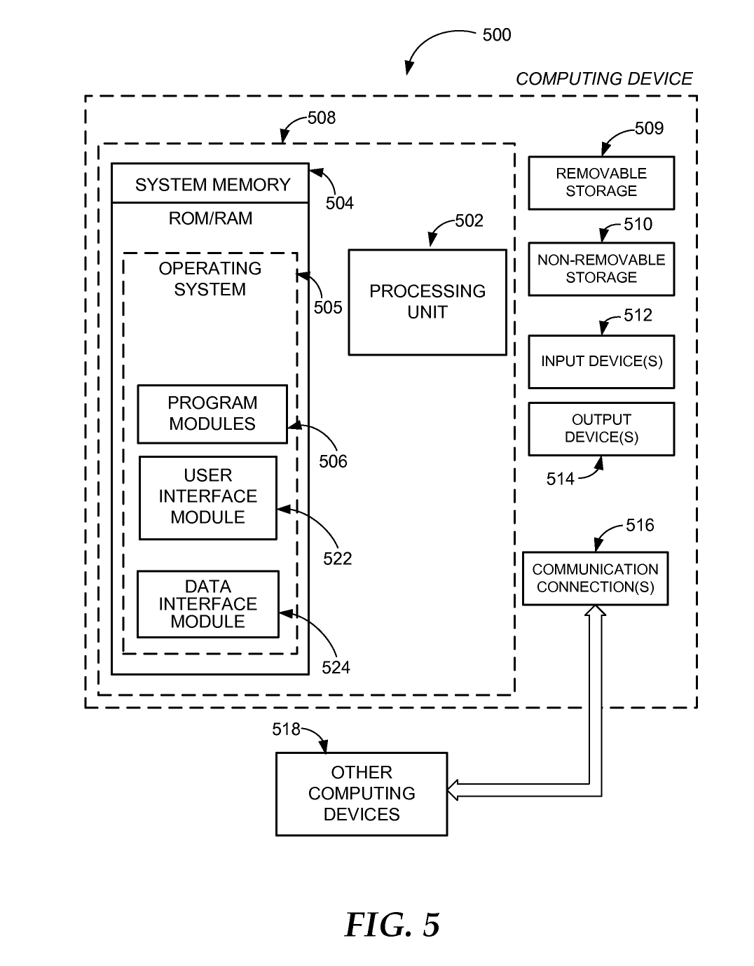

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as program modules 506, user interface module 522, and data interface module 524.

User interface module 522 may be part of a service providing data presentation, computation, analysis, and similar services. Data interface module 524 may interact with a database to retrieve datasets in response to user selection and movement of the datasets from one surface to another presented by the user interface module 522. An application managing both modules may combine datasets and display the query that produced the combined datasets. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. Computer readable storage media is a non-transitory computer readable memory device. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications, storage servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

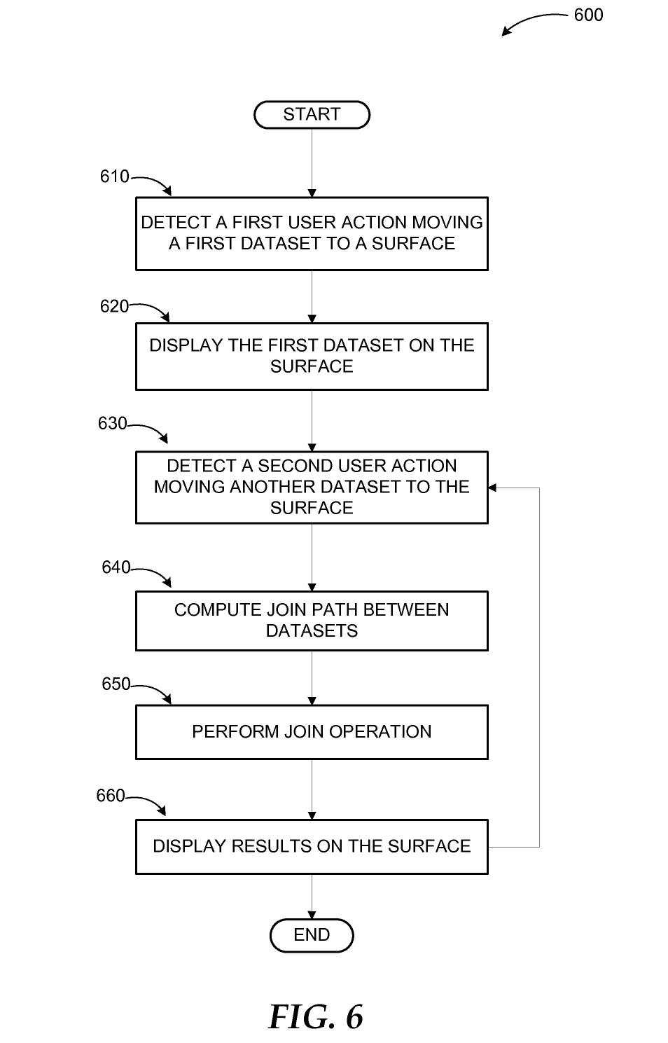

FIG. 6 illustrates a logic flow diagram for a process employing a data driven natural interface for automatically composing relational queries according to embodiments. Process 600 may be implemented by a locally installed or hosted application on any computing device.

Process 600 may begin with operation 610, where a first user action moving a first dataset from a first surface to a second surface is detected. Operation 610 may be followed by displaying the first dataset on the second surface at operation 620. The application may then detect a second user action moving another dataset from the first surface onto the second surface (e.g., drag and drop a data column from a data table) at operation 630.

The application may compute a join path between the moved datasets or request the database to determine the join path at operation 640. Operation 640 may be followed by operation 650, where the join operation is performed. The results of the join operation (query execution) may be displayed on the second surface at operation 660. If the user moves additional datasets to the second surface, additional join operations may be performed (i.e., queries formed and executed) and their results displayed without a need for manual intervention from the user as shown by the loop between operations 660 and 630.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 600 are for illustration purposes. Data driven natural interface to compose relational queries on client applications according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part by a computing device for providing a data driven natural interface for automatically composing relational queries, the method comprising:
displaying a plurality of datasets on a first surface;
detecting a first user action associated with a first dataset from the plurality of datasets on the first surface;
detecting a second user action associated with a second dataset from the plurality of datasets on the first surface;
constructing a query for combining the first and second datasets;
executing the query; and
displaying the first and the second datasets and a result of the query on a second surface.

2. The method of claim 1, further comprising causing the query to be constructed and executed at a remote data store.

3. The method of claim 1, further comprising:
detecting another user action associated with another dataset from the plurality of datasets on the first surface;
constructing a new query for combining the other dataset with existing query results;
executing the new query; and
displaying a result of the new query without necessitating the user to test and execute the query manually.

4. The method of claim 1, wherein the first and second user actions include selecting and moving the respective datasets to the second surface.

5. The method of claim 4, wherein selecting and moving a dataset to the second surface includes enabling the user to grab and drag a data column header to the second surface.

6. The method of claim 4, wherein selecting and moving a dataset to the second surface includes enabling the user to grab and drag an entire data column to the second surface.

7. The method of claim 4, wherein selecting and moving a dataset to the second surface includes enabling the user to grab and drag a plurality of data cells to the second surface.

8. The method of claim 1, wherein the first dataset and the second dataset include at least one from a set of: a data column, a data row, and a data cell.

9. The method of claim 1, wherein constructing the query includes computing a join path between the first and second datasets.

10. The method of claim 9, wherein executing the query includes performing a join operation between the first and second datasets.

11. The method of claim 1, further comprising:
displaying the plurality of datasets in form of a grid with column headers on the first surface.

12. A computing device capable of providing a data driven natural interface for automatically composing relational queries, the computing device comprising:
a memory;
a processor coupled to the memory, the processor executing an application in conjunction with instructions stored in the memory, wherein the application is configured to:
display a plurality of datasets on a first surface;
detect a first user action moving a first dataset from the plurality of datasets from the first surface to a second surface;
detect a second user action moving a second dataset from the plurality of datasets from the first surface to the second surface;
cause a data store to construct a query for combining the first and second datasets;
cause the data store to execute the query;
receive a result of the query from the data store; and
display the first and the second datasets and the result of the query on the second surface.

13. The computing device of claim 12, wherein the query is one of:
a one-to-many join query joining the first dataset with the second dataset on a foreign key of the first dataset in the second dataset;
a many-to-one join query joining the first dataset with the second dataset on a foreign key of the second dataset in the first dataset; and
a many-to-many join query joining the first dataset with the second dataset by creating a matrix for each element of the first dataset with each element of the second dataset.

14. The computing device of claim 12, wherein the first and second surfaces are bounded surfaces within a user interface of the application adjacent to each other and separated by a divider.

15. The computing device of claim 14, wherein at least one from a set of: a size of the first surface, a size of the second surface, a size of the divider, and a location of the divider are user adjustable.

16. The computing device of claim 12, wherein at least one of the first and second surfaces is an unbounded area on a desktop presented by the computing device.

17. The computing device of claim 12, wherein the data store includes one of: a collection of files, a data service, a data server, and a relational database.

18. A computer-readable memory device with instructions stored thereon for providing a data driven natural interface for automatically composing relational queries, the instructions comprising:
displaying a plurality of datasets on a first surface in a grid form with column headers;
detecting a first user action moving a first dataset from the plurality of datasets from the first surface to a second surface;
detecting a second user action moving a second dataset from the plurality of datasets from the first surface to the second surface;
causing a data store to construct a query for performing a join operation between the first and second datasets;
causing the data store to execute the query;
receiving a result of the query from the data store; and
displaying the first and the second datasets and the result of the query on the second surface.

19. The computer-readable memory device of claim 18, wherein the instructions further comprise:
displaying the constructed query; and
enabling a user to modify the query prior to the query being executed.

20. The computer-readable memory device of claim 18, wherein the instructions further comprise automatically adjusting at least one of a size and a location of the first and second surfaces based on displayed and moved datasets.
